(19) United States
(12) Patent Application Publication
(10) Pub. No.: US 2009/0000169 A1
(43) Pub. Date: Jan. 1, 2009

(54) Portable presentation display device

(76) Inventors: Vazgen Houssain, Paramus, NJ (US); Diedre Murphy, Paramus, NJ (US)

Correspondence Address: Stephan E. Feldman, PC, 7th FL, 12 E. 41st Street, New York, NY, 10017, US

(21) Appl. No.: 11/818,290

(22) Filed: Jun. 14, 2007

(51) Int. Cl. G09F 7/00

(52) U.S. Cl. 40/605; 40/584

(57) ABSTRACT

The present invention comprises a presentation display device that is portable and easy to assemble and disassemble. The invention includes a plurality of movably hinged display panels as described. The display panels are composed of a foam core material coupled between two outer sheet layers made of foldable, tear resistant material. The invention also includes a connecting means comprising a removable connecting bracket which may be used to attach one or more display panels along the outer edges of the movable hinged panels thereby expanding the height and width of the display area of the device. The disclosure further includes a support means comprising a detachable support bracket used to vertically stabilize the device while it sits above a planar surface such as the floor, or a desktop.

### FIELD OF THE INVENTION

The present invention relates, generally, to presentation display boards, and more particularly, to a portable presentation display device having multiple display panels with a detachable support mechanism to provide the display board with upright stability.

### BACKGROUND OF THE INVENTION

Most of the portable presentation display boards marketed to consumers today are extremely cumbersome to open and assemble, or they generally lack vertical stability when assembled and standing upright above a flat surface such as a tabletop or on the floor. In addition, these display boards are equally as difficult to disassemble, transport, and store after they are no longer being used. Some of these presentation display devices are described below.

U.S. Pat. No. 7,040,899 issued to Armstrong discloses a portable display presentation case having a plurality of lightweight, rigid panels; the device has a set of mechanical hinges that connect the panels to one another allowing the panels to fold from an open position to a closed position. The device also has a handle fixedly secured to the top of one of the display panels.

U.S. Pat. No. 5,960,848 issued to Schirer discloses a display having three (3) display areas comprising a right portion, center portion and left portion. The center display portion includes a header portion that folds out over and secures onto both the left and right portions when the display is fully assembled.

U.S. Pat. No. 2,526,603 issued to Damroth discloses a multiple panel display board having a plurality of separately aligned panels wherein each panel is formed around an outer wooden frame.

U.S. Pat. No. 3,608,221 issued to Harris discloses a collapsible display structure comprising a plurality of panel units, each of which includes a panel board element which is carried in a peripheral supporting frame. The frames are composed of lengths of extrusion formed with longitudinal channels for carrying end portions of panel units and for slidably receiving supporting legs.

Accordingly, there is needed a presentation display board that is both portable and sturdy enough when assembled that it will maintain its freestanding, upright position atop a planar surface. Moreover, such a presentation display device would substantially reduce most of the inherent difficulties associated with using most of today's display boards, such as difficulties in transporting and storing the device before and after assembly and set-up. None of the above inventions and patents, taken either singly or in combination, is seen to describe the present invention as claimed.

### SUMMARY OF THE INVENTION

The present invention achieves technical advantages as a portable presentation display device that conveniently allows a user to quickly assemble and disassemble the device for easy transport or storage. Moreover, the present invention also offers the added advantage of providing greater stability and rigidity while in a freestanding display position.

In one embodiment, the portable display board includes a plurality of foldably hinged panel sections made of compressed foam composite material, form core. The panels are adapted to easily collapse into one another, forming a compressed unit of stackable panels when the device is disassembled and ready to be transported. The portable presentation board also includes a connecting means comprising a H-shaped dual-channeled bracket that is removably coupled to the set of hinged panels so as to allow for additional stacking of separate display panels on to the foldable hinged panels to create a wider display area. In a preferred embodiment, the H-shaped channel bracket also provides the presentation board with added sturdiness and stability when additional and separate display panels are attached to hinged panel section.

The presentation display board also includes a base support means comprising a base support bracket that may be detachably coupled to the base of the display device and functions to stabilizes the device as it stands upright over a flat surface, such as tabletop or on the floor. Preferably, the base support bracket comprises two (2) opposing insert channels so as to allow the bracket to be insertably attached to the outer edge of which each display panel. The base support bracket operates to form a 90° degree angle connection between the display board and the surface upon which the board sits, such that it advantageously functions to prevent the display device from accidentally being tipped over while standing upright over a substantially planar surface such as a desktop, countertop, or on the floor.

In another embodiment the present invention includes at least six (6) foldably hinged panels having a pair of first and second outer hinge panels wherein the outer hinge panels may be moved at predetermined angles so that the display device can maintain its vertical upright position above a planar surface after it has been assembled.

### BRIEF DESCRIPTION OF THE DRAWINGS

Advantages of the invention and the specific embodiments will be understood by those of ordinary skill in the art by reference to the following detailed description of preferred embodiments taken in conjunction with the drawings, in which:

FIG. 1 shows a front, perspective view of the a portable presentation display device in accordance with an exemplary embodiment of the present invention;

FIG. 2 shows a front perspective view of the portable presentation display device including a stacking means comprising a H-shaped stacking bracket and base support means comprising a base support bracket in accordance with the present invention;

FIGS. 3a, 3b, 3c, 3d, 3e, and 3f show side views of the different attaching and support members used to connect multiple display panels in accordance with the present invention;

FIG. 4 shows a perspective view of a fully assembled portable presentation board in accordance with the present invention;

FIG. 5 shows a perspective view of a collapsed presentation board in accordance with the present invention; and

FIG. 6 shows a perspective view of a partially collapsed presentation display board in accordance with the present invention.

FIG. 7 shows a perspective view of a two level presentation display board in accordance with the present invention.

### DETAILED DESCRIPTION OF THE PREFERRED EMBODIMENT

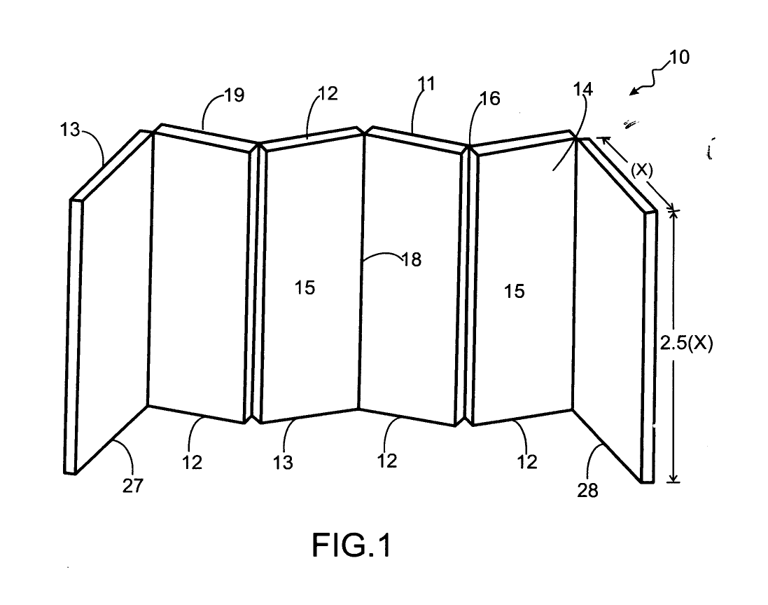

FIG. 1 shows a front, perspective view of a partially assembled portable presentation device 10 and in accordance with an exemplary embodiment of the present invention. The present invention includes six movably coupled display panels 12 made of lightweight foam core 19 which is approximately a half-inch (½″) in thickness. The foam core 19 includes two outer sheets 11 and 14 forming the basic embodiment of the invention. Further shown is a segmented array of foldably connected panels 12 formed from the cut 16 and score 18 lines on the outer sheet material 11 and 14. The outer sheets 11 and 14 comprise paper-like material that is both foldable and tear resistant and is adapted to form a smooth display surface 15 upon which display items may be posted, such a written messages or notes, or displays for example. As shown, the preferred measured length of each panel segment 12 is approximately two and an half times (2.5×) its width (x); however, it should be understood that each individual panel segment 12 may be designed to have varying dimensions of length and width.

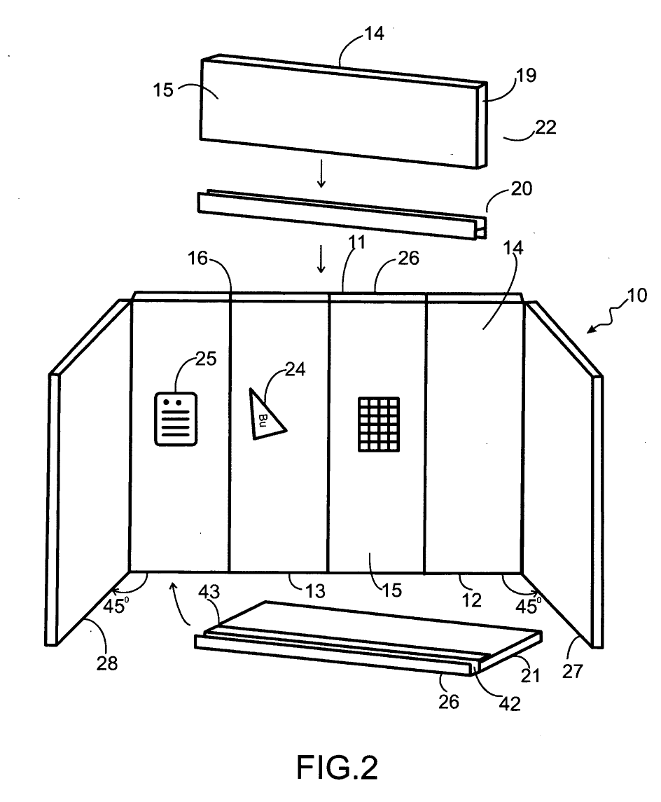

Referring now to FIG. 2, there is shown a portable presentation display device 10 including a connecting means comprising a H-shaped connecting bracket 20 and a base support means comprising a base support bracket 26 in accordance with the present invention. Unlike FIG. 1, the presentation board 10 is shown fully assembled wherein four of the six hinged-panels 12 merge to form a uniform flat display surface to which display items 24 may be affixed or messages 25 posted. The two end panels 27 and 28 are shown rotated at an angle of about 45° relative to the other four inner hinged panels 12 and 13 so as to stabilize the display unit 10 as it standing an upright position over a flat surface, such as the floor or a desktop, or a counter top. In one preferred embodiment, the invention is seen to include a connecting means comprising a connecting bracket 20 that may be removably coupled to the top edge 26 of a hinged display panel 12 to allow a separate single panel 22 to be added thereto. As such, the connecting bracket 20 advantageously allows a user to attach an additional panel 22 to the set of hinged-panels 12 to widen the overall display area used for displaying select items 24 or posted messages 25 or for use in school science fairs.

In a select embodiment, the invention 10 is also seen to include a support means comprising a support bracket 26 that attaches to the bottom edge of the hinged-panel unit 10. The support bracket 26, as shown, is adapted to support and stabilize the presentation display device 10, preventing it from tipping over as it stands in the upright display position above a flat surface. Preferably, the support bracket 26 is of a predetermined length such as about the width of two or three panels and a width of about the width of a display panel and made of reinforced, lightweight material (e.g., plastic or wood) and has two receiving channels 42 and 43 which are adapted to hold two display panels 12 and 21 firmly together in place. Moreover, the outer edges of the outer surface layers 11 and 14 along the outer edges of each display panel 12 and 21 may be slightly hardened or shaved so as to allow for the outer edge portion of each panel to be smoothly and tightly insert into each respective receiving channel 42 and 43 of the support bracket 26 when the presentation display device 10 is being assembled or disassembled.

In operation, the support bracket 26 is removably coupled to the bottom edges of the vertically hinged panels 12, 13 and a separate panel unit 21 via receiving channels 42 and 43 thereby forming a 90° degree angle relative to the hinged panels 12 and the planar surface 37. Once in place, the support bracket 26 advantageously, prevents the display device 10 from rocking or teetering as specific items or messages are posted onto or removed from the display panel surface 15.

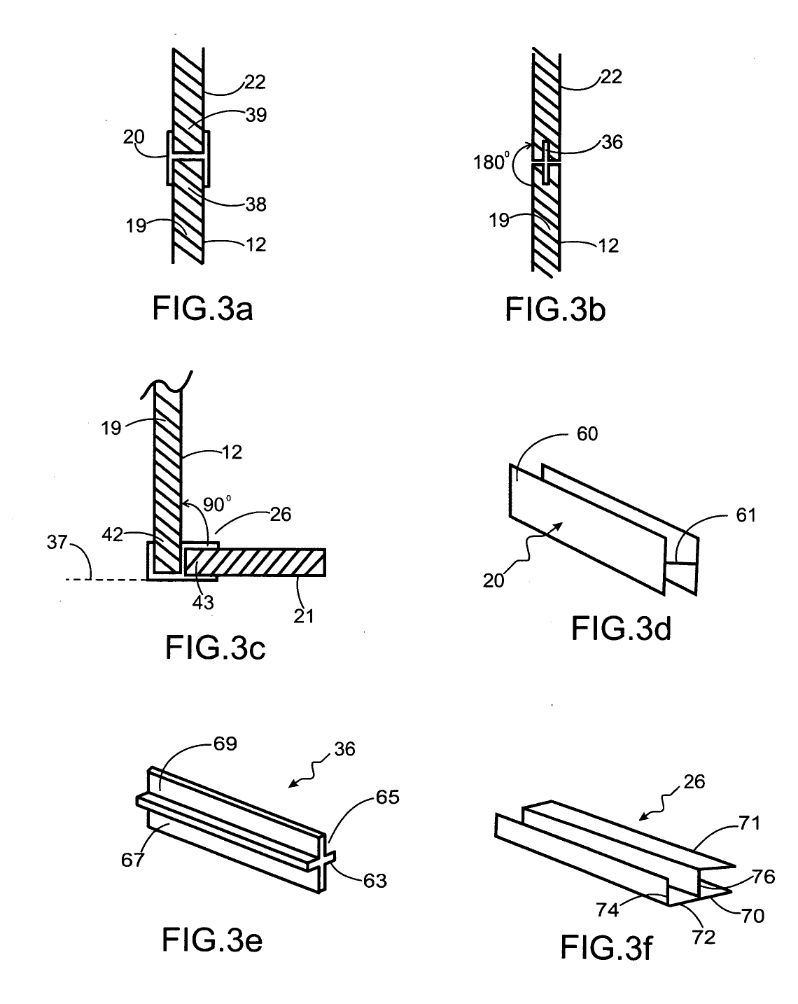

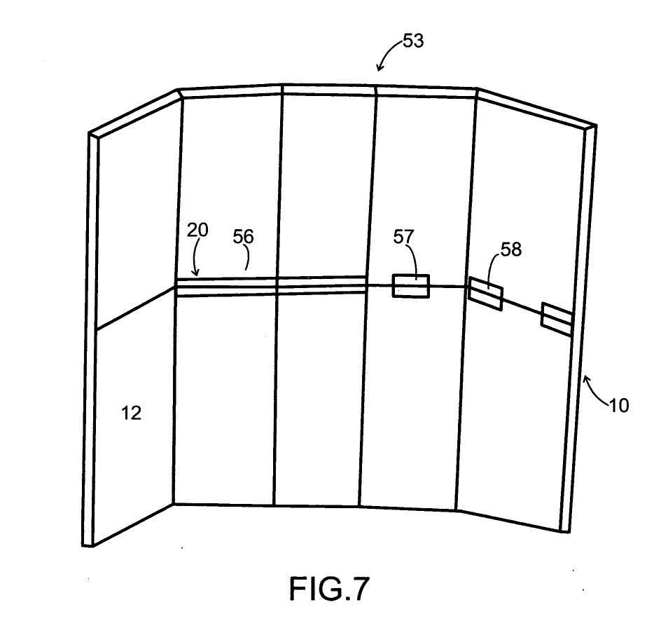

Turning now to FIGS. 3a, 3b, and 3c, there is shown side views of the different connecting means used to connect one or more display panels to the device 10 in accordance with an embodiment of the present invention. FIG. 3a, FIG. 3d, and 2 show an H-shaped connecting bracket 20 made of plastic or metal or other similar material having two vertical and one horizontal members. The vertical members are approximately the height of the horizontal member and include first and second receiving channels 38 and 39, which are adapted to receive the display panels. The channels are adapted to receive panels positioned one above the other so that the upper display panel 22 FIG. 7 can be placed on top of and rigidly secured to the bottom display panel 10, (the same display panel shown in FIG. 1). The brackets 20 may be as long as the width of a display panel as shown by bracket 56 or may be shorter such as about ⅓ of the width of a display panel as shown by brackets 57. The bracket may also be even shorter and placed at the ends as shown at 58. There also may be other configurations of the bracket.

With regard to FIGS. 3b and 3e an elongated cross-shaped connecting bracket 36 made of plastic, metal or other strong matter is shown embedded into the foam core material 19. In this instance, the individual display panels 12 and 22 are connected vertically as shown in FIG. 7 but via the embedded cross-shaped bracket 36, so as to provide for a strong rigid connection with a more seamless and visually appealing panel-to-panel connection. Although a single elongated cross-shaped bracket 36 is illustrated, it should be understood that a connecting bracket of varied length may be used and may be of sufficient length to extend over the entire width of a panel, it also or may be smaller. It may be approximately a third or half the width of a panel and placed in the center or ends of the panel.

The horizontal member 63 which is approximately the same thickness as the foam core of the panel while the vertical members 65 are pointed and each (both lower and upper members 67 and 69) may be the same or about double or triple the length of the thickness of the foam core panel.

In FIG. 2, 3c and 3f a support bracket 26 is used as a stand for holding display panels 12 and a support panel (which may be a display panel or may be of other material 21) is held at a substantially a 90° degree angle relative to the display panel. Preferably, the support bracket 26 is designed to include two opposing receiving channels 42 and 43 so as to allow the elongated support bracket 26 to be insertably slid along the outer edges of both the display panels 12 and the support panel 21. In use, the support bracket 26 is affixed to the bottom edge of the vertically hinged display panels 12 and a single horizontal panel unit 21 such that a firm support base upon which the presentation display device 10 will sit is provided. In this case, although one type of detachable support bracket 26 is illustrated, other types of support brackets that may be used to firmly support the presentation display device 10. Support bracket 26 has horizontal members 72 and 70 from which vertical legs 74 and 76 project. Horizontal member 71 projects from leg 76. The distance between members 71 and 70 is approximately the thickness of the support panel, while the distance between legs 74 and 76 is the thickness of the foam core panel. The support panel is usually the same thickness as the foam core panel.

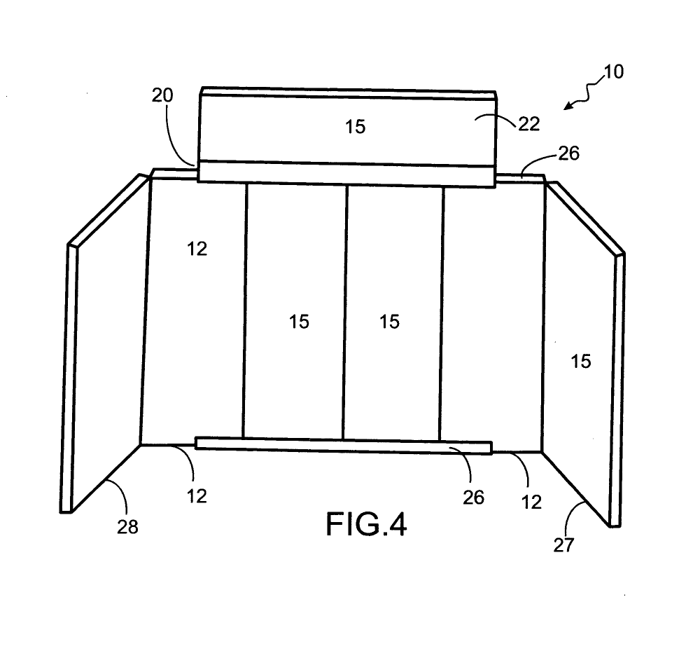

Referring to FIG. 4, there is shown a perspective view of a fully assembled, upright portable presentation display device 10 in accordance with the present invention. As shown, two outer-hinged panels 27 and 28 may be slightly rotated at predetermined angles relative to the four inner display panels 12 so as to further add to the upright stability of the invention as it sits atop a planar surface. Although the overall physical dimensions of the presentation display device 10 may measure 4 ft×4 ft, it should be understood that the present invention may be manufactured using any number of physical dimensions, such as 4 ft×8 ft, 6 ft, for example.

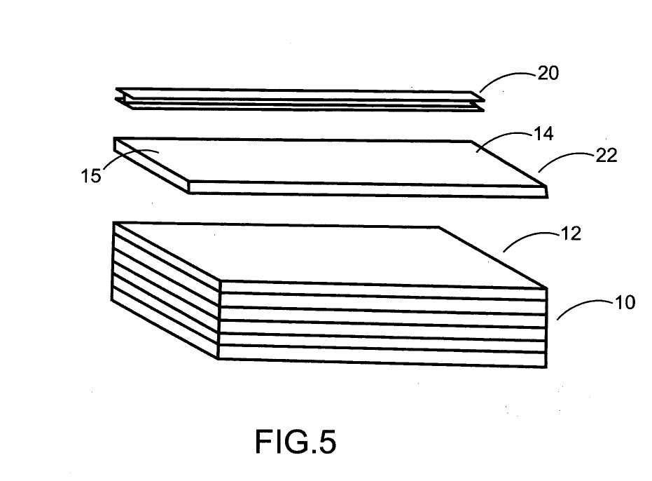

With regard to FIG. 5, a perspective view of the present invention is shown wherein the foldable display panels 12 collapse and thus may be conveniently folded and stacked one on top of the other once the display device 10 is disassembled. In this instance, the collapsible nature of the device 10 coupled with the lightweight characteristics of each hinged-panel 12, advantageously, allows users to easily carry away and store the device 10 and therefore convenient to use for high school science fairs.

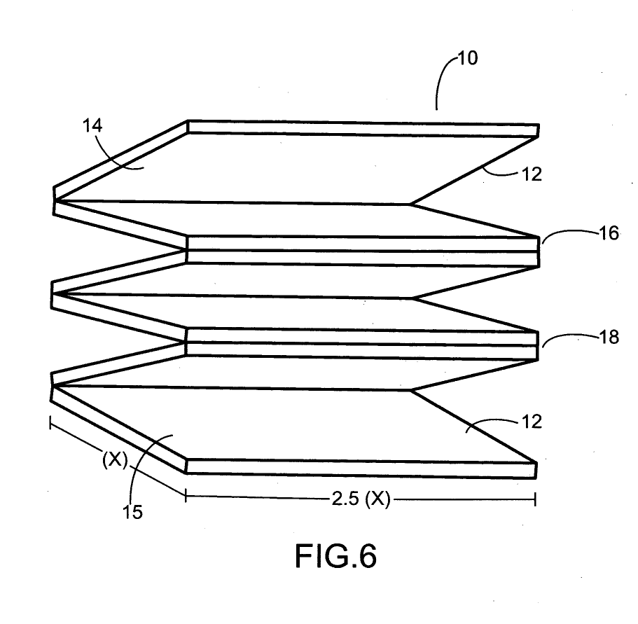

Referring to FIG. 6, there is shown a partially collapsed presentation display device 10 in accordance with the present invention. As shown, the presentation device 10 may be conveniently transported and stored after it is disassembled. Preferably, the length each panel segment 12 is approximately two and a half to three times its width. It should be noted, however, that each individual panel segment 12 may be manufactured so as to have varying dimensions of length and width.

The numerous innovative teachings of the present applications will be described with particular reference to the presently preferred exemplary embodiments. However, it should be understood that this class of embodiments provides only a few examples of the many advantageous uses and innovative teachings herein. In general, statements made in the specification of the present application do not necessarily delimit any of the various claimed inventions. Moreover, some statements may apply to some inventive features, but not to others.

Though the invention has been described with respect to specific preferred embodiments, many variations and modifications will become apparent to those skilled in the art upon reading the present application. It is therefore the intention that the appended claims be interpreted as broadly as possible in view of the prior art to include all such variations and modifications.

We claim:

1. A portable presentation display device, comprising:
a plurality of movably hinged display panels, said hinged panels having a display surface for displaying selected items;
a removable connecting means for removably connecting a separate first panel to said plurality of hinged panels; and
a removable supporting means for stabilizing said portable presentation display when said display is assembled and sitting up right over a substantially planar surface,

2. The display device as specified in claim 1 wherein said hinged display panel comprises a foam core, said foam core is coupled between two outer sheet layers, said hinged panels are formed via a series of scored lines over the surface of said outer sheet layers.

3. The display device as specified in claim 2 wherein said outer-sheet layers comprise foldable, tear-resistant material, said outer sheet layers are adapted to form a flat display surface.

4. The display device as specified in claim 1 wherein said connecting means comprises an H-shaped connecting bar, said connecting bracket having at least two receiving channels for holding said display panels substantially vertically to one another.

5. The display device as specified in claim 1 wherein said support means comprises a horizontal support bracket, said support bracket having a least two receiving channels for holding a display panel vertically.

6. The display device as specified in claim 1 wherein said connecting means further comprises a cross-shaped connecting bracket, said cross-shaped connecting bracket is adapted to hold two display panels stacked above each other at a 180° degrees relative to one another.

7. The display device as specified in claim 6 wherein said cross-shaped connecting bracket is comprised of plastic and is embedded into the foam composite material of said hinged display panels.

8. The display device as specified in claim 2 wherein said outer sheet layers are adapted to form a flat display surface for receiving a selected display item.

9. A portable presentation display device, comprising:
a plurality of movably hinged display panels comprising foam core material, said hinged panels having two outer side panels and a set of inner panels, said outer side panels rotate at predetermined angles relative to said inner panels to allow said display device to sit upright above a planar surface, said inner panels are aligned so as to form a substantially flat display surface for displaying a select item,
whereby said plurality of hinged display panels are adapted to fold and stack one on top of the other when the presentation device is disassembled.

10. The display device as specified in claim 9 further comprising a connecting means for removably connecting a separate first panel to said plurality of hinged panels such that the net display area of said display device is increased.

11. The display device as specified in claim 9 further comprising a support means for stabilizing said display when said hinged display panels are assembled and sitting up right over a substantially planar surface.

12. The display device as specified in claim 10 wherein said connecting means comprises as H-shaped connecting bracket, said connecting bracket having at least two receiving channels for holding said display panels substantially at a 180° degree angle of one another.

13. The display device as specified in claim 11 wherein said support means comprises an support connecting bracket, said support bracket having a least two receiving channels to hold two display panels substantially at a 90° degree angle of one another.

14. The display device as specified in claim 9 wherein said foam core material is coupled between two outer sheet layers, said outer layer comprises paper.

15. The display device as specified in claim 14 wherein said outer-sheet layers comprise foldable, tear-resistant material, said outer-sheet layer is adapted to form a flat display surface.

16. The display device as specified in claim 14 wherein said hinged display panels are formed via a series of score and cut lines across the surface of said outer sheet layers.

17. The display device as specified in claim 9 wherein said hinged panels comprise at least six (6) hinged panels.

18. A portable presentation display device, comprising:
at least six movably hinged display panels, said hinged panels having two opposing side panels;
an H-shaped connecting bracket removably coupled to a least one of said hinged display panels, said connecting bracket is adapted to connect a separate first panel to said single hinged panel; and
a support bracket removably coupled to a least one hinged display panel and a second panel, said support bracket is adapted to stabilize said portable presentation display is assembled and sitting up right above a substantially planar surface,
whereby said plurality of hinged display panels are adapted to fold and stack one on top of the other when said presentation device is disassembled.

19. The display device as specified in claim 18 wherein said hinged display panel comprises a foam core material.

20. The display device as specified in claim 18 wherein said connecting means further comprises a T-shaped connecting bar, said T-shaped connecting bracket is adapted to hold two display panels at a 1800 degrees relative to one another.
